(19) United States
(12) Patent Application Publication
(10) Pub. No.: US 2024/0054841 A1
(43) Pub. Date: Feb. 15, 2024

(54) SYSTEM AND METHOD OF USING PLASMONIC NANOPARTICLES FOR ANTI-COUNTERFEIT APPLICATIONS

(71) Applicant: The Trustees of Indiana University, Bloomington, IN (US)

(72) Inventors: Sara E. Skrabalak, Bloomington, IN (US); Alison F. Smith, Bloomington, IN (US); Joshua D. Smith, Avon, IN (US)

(73) Assignee: The Trustees of Indiana University, Bloomington, IN (US)

(21) Appl. No.: 17/766,480

(22) PCT Filed: Oct. 8, 2020
(86) PCT No.: PCT/US2020/054670

§ 371 Date: Apr. 4, 2022

Related U.S. Application Data
(60) Provisional application No. 62/912,755, filed on Oct. 9, 2019.

(51) Int. Cl. G07D 7/1205; G07D 7/202; B41M 3/14

(52) U.S. Cl. CPC G07D 7/1205; G07D 7/205; B41M 3/144

(57) ABSTRACT

A method of using at least one nanoparticle for an anti-counterfeit application including selecting the at least one nanoparticle having a non-spherical configuration; providing the at least one nanoparticle on a substrate; providing a light to the at least one nanoparticle; determining a position of the at least one nanoparticle based on providing the light to the at least one nanoparticle; determining a color of the at least one nanoparticle based on providing the light to the at least one nanoparticle; defining a nanofingerprint based on the position and the color of the at least one nanoparticle; and recognizing the nanofingerprint.

### CROSS-REFERENCE TO RELATED APPLICATIONS

The present application claims priority to U.S. Provisional Patent Application Ser. No. 62/912,755, filed Oct. 9, 2019, and entitled “SYSTEM AND METHOD OF USING PLASMONIC NANOPARTICLES FOR ANTI-COUNTERFEIT APPLICATIONS,” the complete disclosure of which is expressly incorporated by reference herein.

### GOVERNMENT SUPPORT

This invention was made with government support under 1306853 and 1602476 awarded by the National Science Foundation. The government has certain rights in the invention.

### TECHNICAL FIELD

This disclosure relates generally to nanoparticles for anti-counterfeiting applications, and more particularly, to anisotropic plasmonic nanoparticles configured to produce a unique “fingerprint” or identification pattern for anti-counterfeiting applications.

### BACKGROUND

Certain industries, such as pharmaceutical and electronics, may require methods of identifying counterfeit products. For example, pharmaceutical companies may be concerned with ensuring that products under their labels are, in fact, proper and legitimate products. Similarly, electronics companies also have a desire to ensure that products under their labels are genuine. However, given the nature of the products produced in these industries, it may be difficult to easily identify a counterfeit product.

It is known that nanoparticles (“NPs”) may be used for anti-counterfeiting applications. For example, far-field scattering of randomly deposited gold (Au) NPs is demonstrated as a physically unclonable optical function for anti-counterfeit applications in which the scattering patterns are easily produced and impractical to replicate. In other words, NPs can create a unique scatter pattern or “fingerprint” when exposed to certain conditions (e.g., light). Because of this property, NPs, for example gold NPs, may be deposited onto a product (e.g., a label for use in the electronics industry) and the veracity of the product may be authenticated or identified by confirming the scatter pattern created by the NPs.

More particularly, a physically unclonable function (PUF) is an intrinsically random feature that produces a response, when challenged, that is easily evaluated but impractical to duplicate. For example, 500 μm diameter glass beads encapsulated in epoxy can be used to create 10×10 mm² random speckle patterns (i.e., the response) when illuminated (i.e., the challenge) with visible light. Such optical PUFs can be used as anti-counterfeit labels for currency and strategic arms. Anti-counterfeit labels that can be easily fabricated yet difficult to produce as well as be easily characterized or detected are highly sought-after materials. There is a current need in the pharmaceutical and electronics industry for such labels, with the latter having the additional requirement that the entire label should be on the sub-micrometer or micrometer scale. Many anti-counterfeit applications require a unique identification per component rather than having the same tag for all components in a set; i.e., a nanofingerprint versus a nanobarcode.

Yet, even with this method, the encoding capacity is limited to the presence of the scatter pattern from the NPs only. However, because of the nature and scrutiny of products in certain industries (e.g., pharmaceutical), it may be desirable to increase the encoding the capacity of NPs for anti-counterfeiting applications. Therefore, a need exists in various industries for a method of identifying counterfeit products using multiple “fingerprints” or other unique identifiers. Furthermore, sensors that indicate a change in local environment from the tampering or aging of materials are a current need.

### SUMMARY

In one embodiment, a method of using at least one nanoparticle for an anti-counterfeit application including selecting the at least one nanoparticle having a non-spherical configuration; providing the at least one nanoparticle on a substrate; providing a light to the at least one nanoparticle; determining a position of the at least one nanoparticle based on providing the light to the at least one nanoparticle; determining a color of the at least one nanoparticle based on providing the light to the at least one nanoparticle; defining a nanofingerprint based on the position and the color of the at least one nanoparticle; and recognizing the nanofingerprint.

In a further embodiment, a system of using at least one nanoparticle for an anti-counterfeit application comprises at least one processor; one or more computer-readable media having computer-executable instructions embodied thereon; a light source; and a microscope configured to produce at least a first microscopy image of the at least one nanoparticle in response to actuation of the light source at a first polarization angle, and the microscope being configured to produce a second microscopy image of the at least one nanoparticle in response to actuation of the light source at a second polarization angle, and the computer-readable media is configured to identify a color of the at least one nanoparticle at both the first and second polarization angles and compare the color of the at least one nanoparticle to a database stored on the processor.

In one example, the method further includes including an octopodal structure, as the non-spherical configuration, having a first diagonal length is different from a second diagonal length of the at least one nanoparticle.

In another example, the method further includes including a nano-plate structure, as the non-spherical configuration, having a two-dimensional geometric shape with a predetermined height.

In yet another example, the method further includes including a rod-shaped structure, as the non-spherical configuration, having a cylindrical body, a distal rounded end disposed at one end of the cylindrical body, and a proximal rounded end disposed at an opposite end of the cylindrical body.

In still another example, the method further includes determining the color of the at least one nanoparticle scattered on the substrate based on size information of the at least one nanoparticle as the shape information. In a variation, the method further includes including at least one of: a width, a thickness, and a length of the at least one nanoparticle as the size information.

In yet still another example, the method further includes having one or more anisotropic nanoparticles as the at least one nanoparticle.

In a further example, the method further includes detecting the polarization direction of the excitation light source based on a rotational orientation of a polarizer associated with the excitation light source. In a variation, the method further includes detecting a change of color based on the rotational orientation of the polarizer for matching the determined color of the at least one nanoparticle with the change of color. In another variation, the method further includes performing an optical authentication of an article associated with the nanofingerprint based on the change of color associated with the at least one nanoparticle.

In a yet further example, the method includes estimating the determined color using an RGB value.

In another embodiment, a system of using at least one nanoparticle for an anti-counterfeit application is provided. The system includes at least one processor, and one or more computer-readable media having computer-executable instructions embodied thereon. Upon being executed by the at least one processor, the computer-executable instructions cause the at least one processor to: select the at least one nanoparticle having a non-spherical configuration, scatter the at least one nanoparticle on a substrate, generate a nanofingerprint using the at least one nanoparticle scattered on the substrate, determine a color of the at least one nanoparticle scattered on the substrate based on shape information of the at least one nanoparticle and a polarization direction of an excitation light source applied on the at least one nanoparticle, and recognize the nanofingerprint in response to the determined color of the at least one nanoparticle.

In one example, wherein the computer-executable instructions cause the at least one processor to include an octopodal structure, as the non-spherical configuration, having a first diagonal length is different from a second diagonal length of the at least one nanoparticle.

In another example, wherein the computer-executable instructions cause the at least one processor to include a nano-plate structure, as the non-spherical configuration, having a two-dimensional geometric shape with a predetermined height.

In yet another example, wherein the computer-executable instructions cause the at least one processor to include a rod-shaped structure, as the non-spherical configuration, having a cylindrical body, a distal rounded end disposed at one end of the cylindrical body, and a proximal rounded end disposed at an opposite end of the cylindrical body.

In still another example, wherein the computer-executable instructions cause the at least one processor to determine the color of the at least one nanoparticle scattered on the substrate based on size information of the at least one nanoparticle as the shape information; and to include at least one of: a width, a thickness, and a length of the at least one nanoparticle as the size information.

In yet still another example, wherein the computer-executable instructions cause the at least one processor to include one or more anisotropic nanoparticles as the at least one nanoparticle.

In a further example, wherein the computer-executable instructions cause the at least one processor to detect the polarization direction of the excitation light source based on a rotational orientation of a polarizer associated with the excitation light source; to detect a change of color based on the rotational orientation of the polarizer for matching the determined color of the at least one nanoparticle with the change of color; and to perform an optical authentication of an article associated with the nanofingerprint based on the change of color associated with the at least one nanoparticle.

In a yet further example, wherein the computer-executable instructions cause the at least one processor to estimate the determined color using an RGB value.

While multiple embodiments are disclosed, still other embodiments of the presently disclosed subject matter will become apparent to those skilled in the art from the following detailed description, which shows and describes illustrative embodiments of the disclosed subject matter. Accordingly, the drawings and detailed description are to be regarded as illustrative in nature and not restrictive.

### BRIEF DESCRIPTION OF THE DRAWINGS

The above mentioned and other features and objects of this disclosure, and the manner of attaining them, will become more apparent and the disclosure itself will be better understood by reference to the following description of an embodiment of the disclosure taken in conjunction with the accompanying drawings, wherein:

FIG. 1A is a schematic method of using nanoparticles as optical PUFs;

FIG. 1B is a further schematic method of using nanoparticles as PUFs;

FIG. 1C is an additional schematic method of using nanoparticles as PUFs;

FIG. 1D is a further schematic method of using nanoparticles as PUFs;

FIG. 2A is a schematic view of a spherical nanoparticle;

FIG. 2B is a schematic view of an anisotropic rod-shaped nanoparticle;

FIG. 2C is a schematic view of an octopodal nanoparticle;

FIG. 2D is a scanning electron microscopy image of the octopodal nanoparticle of FIG. 2C;

FIG. 2E is a scanning electron microscopy image of the spherical nanoparticles of FIG. 2A;

FIG. 2F is a scanning electron microscopy image of the anisotropic rod-shaped nanoparticles of FIG. 2B;

FIG. 2G is a scanning electron microscopy image of the octopodal nanoparticles of FIGS. 2C and 2D;

FIGS. 2H-2L are further transmission electron microscopy images of the anisotropic rod-shaped nanoparticles;

FIG. 3A illustrates a method of identifying and comparing a nanofingerprint;

FIG. 3B illustrates a further step of the method of FIG. 3A;

FIG. 3C is a further method of identifying and comparing a nanofingerprint;

FIG. 3D illustrates the average RGB values of the features from a first nanoparticle ink produced according to the present disclosure;

FIG. 3E illustrates the average RGB values of the features from a second nanoparticle ink produced according to the present disclosure;

FIG. 3F illustrates a series of micrographs depicting the differences in nanofingerprints based on the substrate or component material to which the nanoparticles are applied;

FIG. 4 illustrates a method of using nanoparticles for anti-counterfeiting applications;

FIG. 5A is an anisotropic nanoparticle having an octopodal shape;

FIG. 5B is a graphical representation of the polarization output of the nanoparticle of FIG. 5A;

FIG. 6A is a schematic view of a series of nanofingerprints at different polarization angles which, collectively, are used to form a tag stack;

FIG. 6B is a series of nanofingerprints at different polarization angles;

FIGS. 7A and 7B illustrate nanofingerprints at different polarization angles;

FIG. 8A is an untagged electronic component;

FIG. 8B is a tagged electronic component;

FIG. 8C is an optical microscopy image of the untagged component of FIG. 8A;

FIG. 8D is an optical microscopy image of the tagged component of FIG. 8B;

FIG. 9 illustrates a series of microscopy images over a time period; and

FIG. 10 is a schematic view of an operating system configured to determine nanofingerprints for anti-counterfeiting applications.

Corresponding reference characters indicate corresponding parts throughout the several views. Although the drawings represent embodiments of the present disclosure, the drawings are not necessarily to scale, and certain features may be exaggerated in order to better illustrate and explain the present disclosure. The exemplification set out herein illustrates an embodiment of the disclosure, in one form, and such exemplifications are not to be construed as limiting the scope of the disclosure in any manner.

### DETAILED DESCRIPTION OF THE DRAWINGS

The embodiment disclosed below is not intended to be exhaustive or limit the disclosure to the precise form disclosed in the following detailed description. Rather, the embodiment is chosen and described so that others skilled in the art may utilize its teachings. One of ordinary skill in the art will realize that the embodiments provided can be implemented in hardware, software, firmware, and/or a combination thereof. Programming code according to the embodiments can be implemented in any viable programming language such as C, C++, HTML, XTML, JAVA or any other viable high-level programming language, or a combination of a high-level programming language and a lower level programming language.

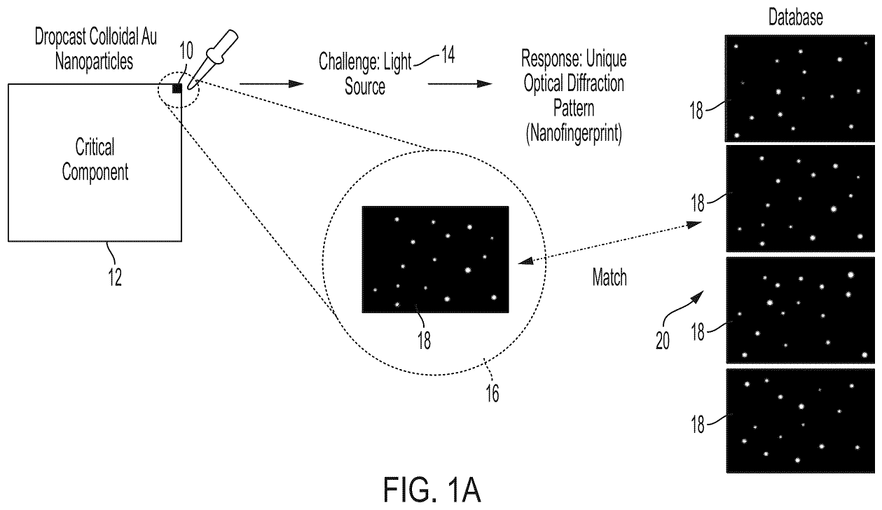

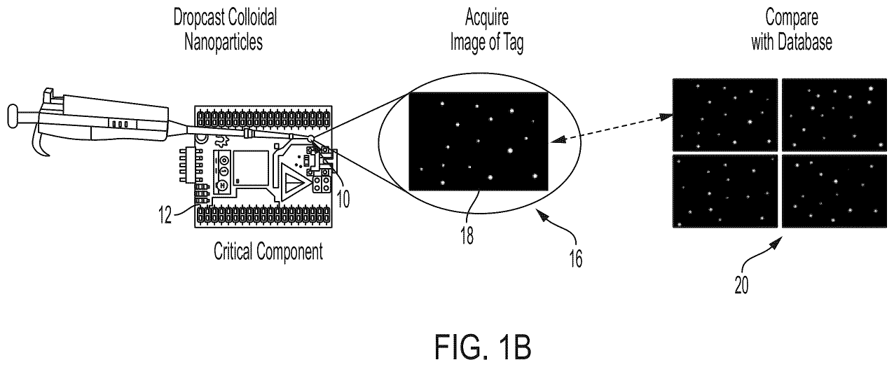

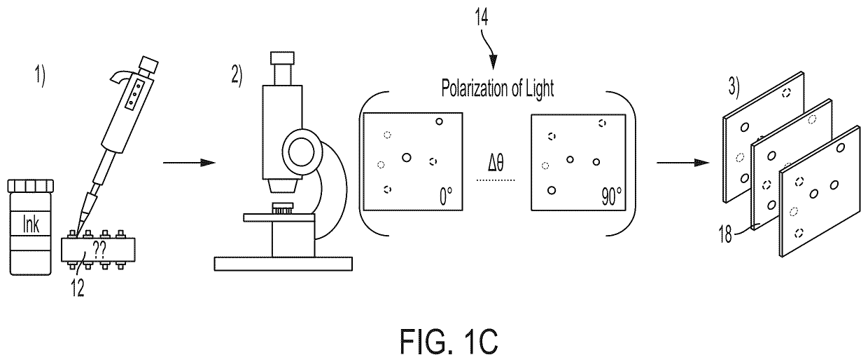

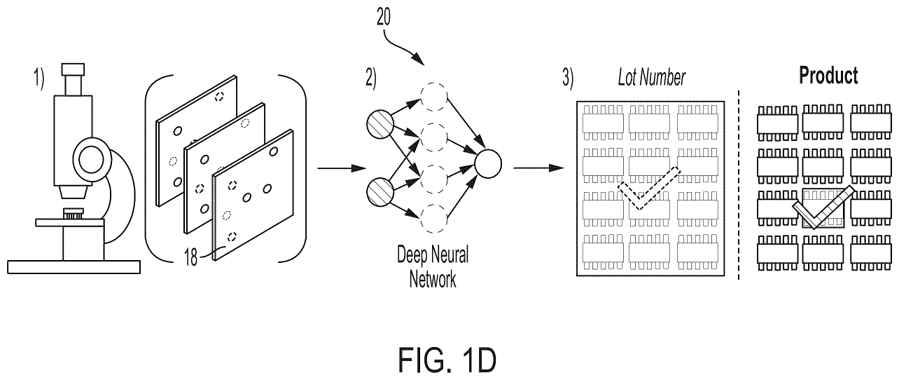

FIGS. 1A-1D show the use of nanoparticles in use for anti-counterfeiting applications. More particularly, FIGS. 1A-1D disclose a method of depositing nanoparticles 10 on a substrate or component 12. In one embodiment, component 12 may be an electronic device (e.g., a chip), a pharmaceutical product or package, a label, or any other member, device, or surface. Illustratively, nanoparticles 10 may be colloidal gold nanoparticles and are deposited onto a surface of component 12 through dropcast techniques. For example, a pipette or other mechanical delivery device may be used, as shown in FIGS. 1A-1D. As disclosed further herein, the size and shape of nanoparticles 10 may be varied such that a mixture of differently-shaped and differently-sized nanoparticles are applied to component 12.

Once nanoparticles 10 applied to component 12, a challenge 14, for example a light source, may be applied thereto, as shown in FIGS. 1A and 1C. Nanoparticles 10 may then produce a response 16 to challenge 14. As shown in FIGS. 1A-D, response 16 may be an optical diffraction pattern or a nanofingerprint or tag 18. More particularly, optical pattern 18 discloses a unique scatter pattern and color of nanoparticles 10 in response to challenge 14 which is not reproducible because the combination of the deposition process with the variations in the size and shape nanoparticles 10 ensures that such scatter patterns are unique. In this way, the method disclosed in FIGS. 1A-1D are suitable for anti-counterfeit tagging.

Referring still to FIGS. 1A-1D, once the nanofingerprint or tag is produced, it may be compared to a database containing multiple scatter patterns or tags. The comparison of tag 18 to database 20 may be done manually or by software or other algorithms (e.g., MATLAB) deployable on electronic devices, such as computers. Artificial intelligence authentication algorithms may be used to allow stacks of tags 18 to be matched to their appropriate lot number, as shown best in FIG. 1D, thereby matching the lot with the product and verifying the authenticity of component 12. It may be appreciated that these 3-D tags 18, which include polarization information, provide an individual product identification.

Anisotropic Nanoparticles

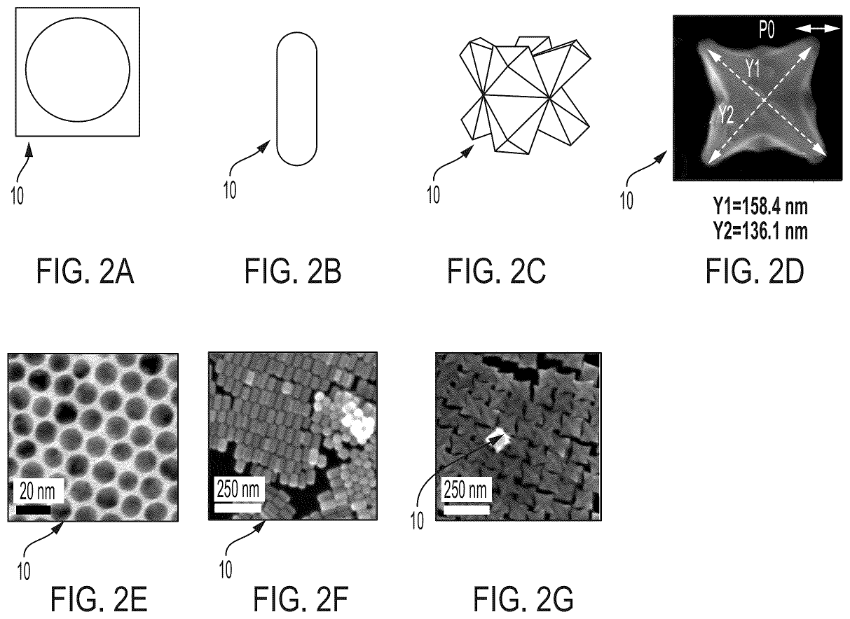

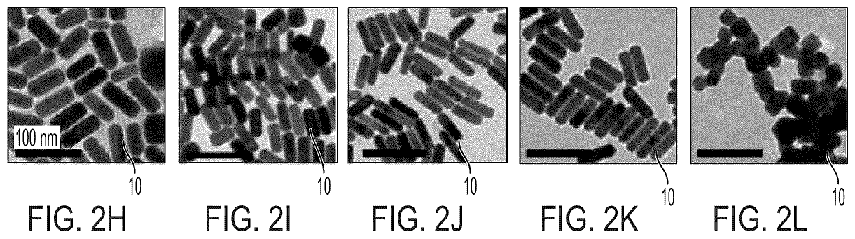

Referring now to FIGS. 2A-2G, nanoparticles 10 may be comprised of a metallic material (e.g., Au, Ag, Al, Cu) and may be have varying shapes and sizes. However, in certain embodiments, non-metallic materials, such as ceramics (e.g., diamond dust), may be used accordingly to the present disclosure. As shown in FIGS. 2A and 2E, spherically-shaped metallic particles (i.e., a constant diameter in three dimensions) or, as shown in FIGS. 2B, 2F, and 2H-2L, rod-shaped particles (i.e., cylindrically-shaped particle with rounded ends such that a length of the particle is greater than a diameter of the particle) may be used. Additionally, nanoparticles 10 may have a rectangular, triangular, hexagonal, octahedral or octopodal (e.g., FIGS. 2C, 2D, and 2G), or any other type of shape having linear and/or rounded or curved surfaces and/or defined by a number or orientation of atoms. More particularly, nanoparticles 10 having the shapes noted herein are plate-like in that the thickness of nanoparticles 10 is less than length and lateral dimensions thereof. As shown in FIGS. 2C, 2D, and 2G, various shapes of nanoparticles 10 may be defined by different lengths along different faces of nanoparticle 10. Illustratively, FIG. 2D discloses an octopodal nanoparticle 10 having a length of approximately 158.4 nm along a first face (“Y1”) and a length of approximately 136.1 nm along a second face (“Y2”).

In addition to the shape, the size of nanoparticles 10 may vary. In various embodiments, nanoparticles 10 may have a length of approximately 30-100 nm and a width of approximately 5-600 nm, however, nanoparticles may have any measured size (e.g., diameter, length, width, height, thickness in the X, Y, and/or Z-directions) within the range 1-999 nm. For example, it is contemplated that nanoplates (i.e., generally two-dimensional materials with a spherical, triangular, rectangular, or hexagonal shape and minimal measured value in one dimension) may be used.

Because nanoparticles 10 may have shapes with different dimensions, nanoparticles 10 can exhibit shape anisotropy (i.e., one dimension in three-dimensional space is different from the other dimensions). In other words, nanoparticles 10 may have different physical properties in each dimension due to the variations in shape and size of different surfaces or faces of nanoparticles. For example, with respect to FIG. 2D, the octopodal nanoparticle 10 shown therein reflect light differently along first face Y1 compared to second face Y2 due to the different lengths of faces Y1 and Y2. As disclosed further herein, the shape anisotropy of nanoparticles 10 allows different reactions to challenge 14 (FIGS. 1A and 1B) such that nanoparticles 10 facilitate the creation of unique tags or “fingerprints” for identification purposes.

Additionally, for nanoparticles 10 having a rod shape, multiple localized surface plasmon resonances (“LSPR”) arising from the oscillation of the electron cloud along the length and width thereof which produce unique light scattering results by changing the polarization angle of the light with respect to the orientation of nanoparticle 10 (e.g., the color red may be observed when the polarized light angle is parallel to the length of the rod, the color green may be observed when the polarized light angle is orthogonal to the length of the rod, and the color aqua, yellow, and/or brown may be observed when the polarized light angle is 0-90° relative to the length of the rod), as disclosed further herein.

Nanoparticle Synthesis

Various growth solutions may be used during the synthesis of nanoparticles 10 and may be scaled according to the amount of nanoparticle production needed. In one embodiment, a growth solution of 25 μL of 100 mM HAuCl₄ may be added to 5 mL of 200 mM hexadecytrimethylammonium bromide (“CTAB”) solution and 4.75 mL of water in a 20 mL scintillation vial. Next, 1200 μL of 10 mM NaBH₄ may be diluted with 800 μL of water. 1 mL of the diluted NaBH₄ may be added to the growth solution under vigorous stirring (e.g., 1200 rpm). After approximately two minutes, the stirring may be stopped and the reaction may be left undisturbed for approximately 30 minutes.

Additionally, a growth solution of approximately 1.23 grams of cetyltrimethylammonium chloride (“CTAC”), approximately 0.31 grams of sodium oleate (NaOL), and approximately 50 mL of water may be dissolved at approximately 50° C. in a 250 mL flask. Once the solids are dissolved, the reaction may be cooled to approximately 30° C. and approximately 2.4 mL of 4 mM AgNO₃ may be added to the growth solution. The mixture may be left undisturbed for approximately 15 minutes.

Further, a 10 mL solution containing approximately 100 μL of 100 mM HAuCl₄ and approximately 9.9 mL of growth solution may be prepared in a scintillation vial. The solutions may be stirred for approximately 150 minutes and a predetermined volume of HCl may be introduced. After another 15 minutes of slow stirring (e.g., 400 rpm), approximately 50 μL of 64 mM L-AA may be added and the solution may be vigorously stirred for approximately 30 seconds. A volume of seed solution may be added to the solution and the reaction may be stirred for approximately 30 seconds. The reaction may be left undisturbed for approximately 12 hours and samples may be concentrated via centrifugation and dispersed in approximately 20 mL of water.

The synthesis process disclosed herein is one example of a method used to produce gold octahedral nanoparticles. It may be appreciated that other methods and materials may be used to also produce nanoparticles 10 for anti-counterfeiting applications and as disclosed herein.

Deposition Process

Referring back to FIGS. 1A and 1B, nanoparticles 10 are deposited onto composite 12 and may be done so through a dropcast process, although other techniques may be used, such as spraying, dipping or dip-coating, or spin coating nanoparticles 10 onto composite 12. In embodiments, nanoparticles 10 may be mixed with an aqueous solution before depositing nanoparticles 10 onto composite 12 in order to limit clustering of nanoparticles 10 and ensure a colorimetric response of individual nanoparticles 10 in the PUF. The solvent in the solution may evaporate leaving only nanoparticles 10 on composite 12. In other embodiments, nanoparticles 10 may be incorporated into a film or coating which is permanently applied to composite 12. In even further embodiments, nanoparticles 10 may be directly incorporated into a portion of component 12, for example incorporated into a top layer or surface of component 12 and/or incorporated into ink, paint, or other material on component 12. Additionally, certain materials of nanoparticles 10 may require a coating or other material applied thereto to prevent oxidation or corrosion. In this way, the process of depositing nanoparticles 10 onto component 12 may be customized for certain products.

The material comprising the surface of component 12 may affect nanofingerprint 18. Many materials comprising surfaces of component 12 are compatible with anisotropic nanoparticles 10 and, therefore, the use of nanoparticles 10 is not limited to applications on components 12 of only certain materials. For example, both the presence of nanoparticles 10 and a color of nanoparticles 10 based on light polarization may be identified when nanoparticles 10 are deposited onto glass, indium tin oxide, silicon (polished and matte), acrylic, polyoxymethylene, poly(methyl methacrylate), polytetrafluoroethylene, high-density polyethylene, acrylonitrile butadiene, polycarbonate, polyvinyl chloride, polychlorotrifluoroethylene, polyphenylene sulfide, polyether ether ketone, gelatin, polyamide, epoxy cresol novolac, and others.

Nanofingerprints

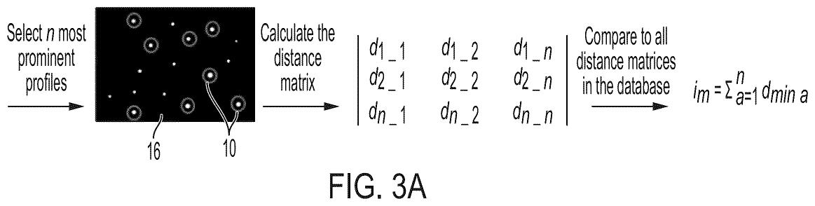

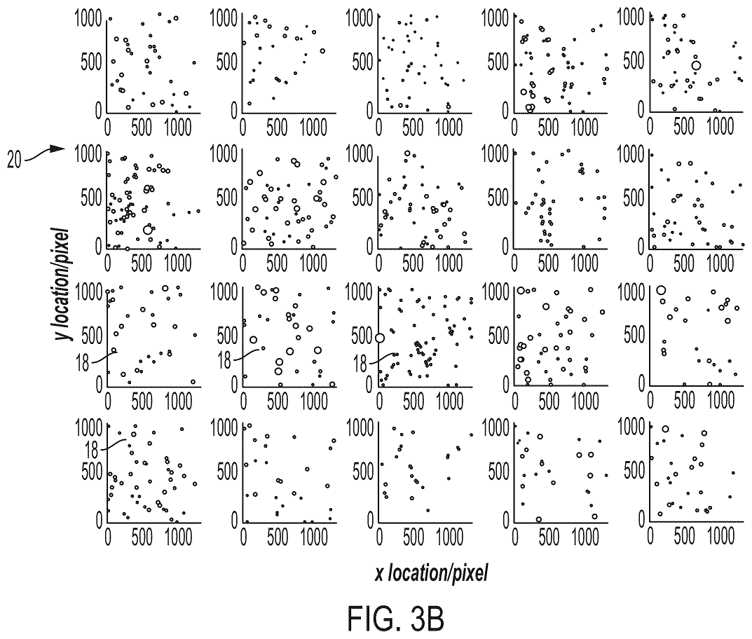

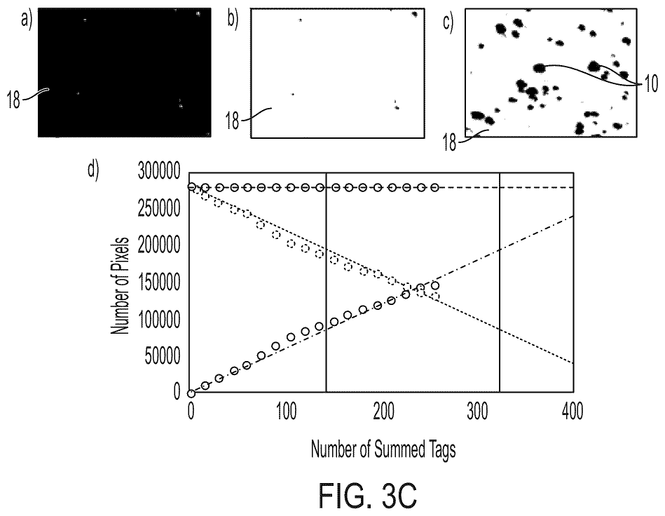

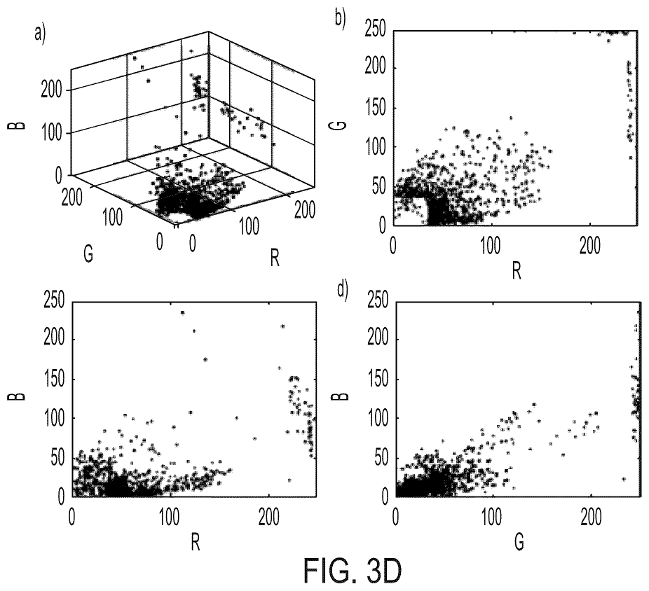

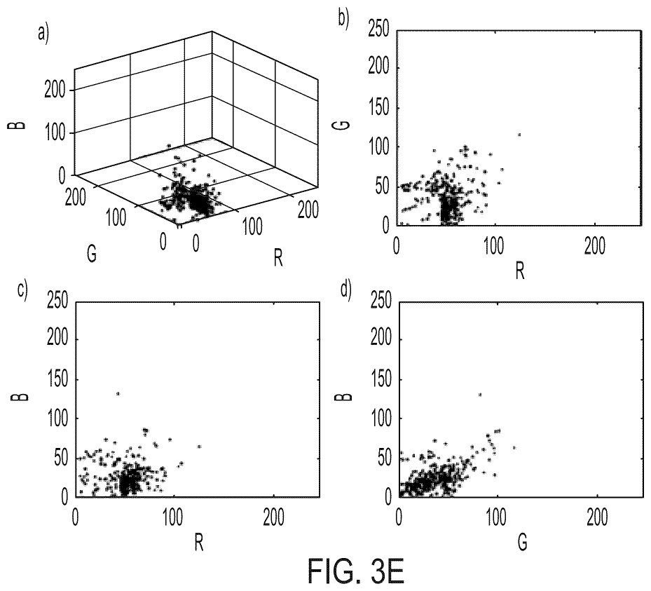

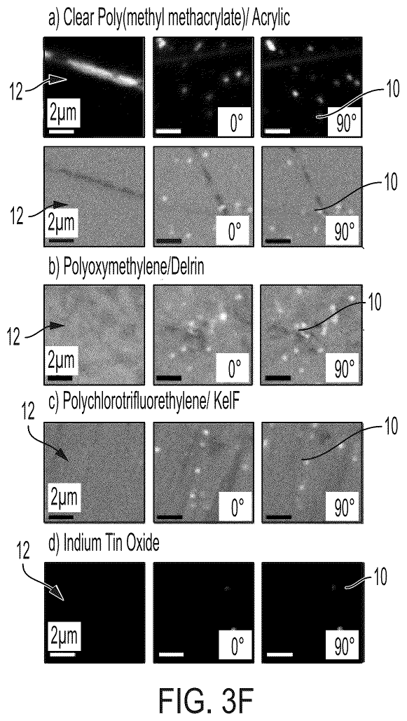

Referring to FIGS. 3A and 3B, nanoparticles 10 may undergo random motion in solution such that the deposition of nanoparticles 10 creates random and unique optical features on component 12 to serve as an anti-counterfeit tag. More particularly, once nanoparticles 10 are deposited onto component 12, challenge 14 (e.g., light in FIGS. 1A and 1B) may be applied to component 12 to record the unique tagging or fingerprinting associated with nanoparticles 10 on a particular component 10. When illuminated with visible light and using microscopy, nanoparticles 10 create unique optical diffraction pattern referred to as nanofingerprint or tag 18. Nanofingerprint 18 may include microscopy images (e.g., scanning electron microscopy) from different light angles (e.g., 0°, 90°, etc.) which result in nanoparticles 10 scattering varying colors of light (e.g., using the RGB color scale) depending on the polarization of the excitation source at those different angles. In other words, to create nanofingerprint 18, light at different angles may be applied to nanoparticles 10 on component 12 and microscopy images may be taken at each of those angles. In one embodiment, light may be applied to nanoparticles 10 on component 12 over a sequence of angles increasing by 10° from 0-90° and microscopy images may be taken at each of those incremental increases in the angle. The parameters of each image taken (e.g., angle of light, magnification, polarization, etc.) may be recorded and compiled with the microscopy images to prepare nanofingerprint 18, which may be important notations because, as shown in FIG. 3F, nanofingerprint 18 may show differences in nanoparticles 10 based on substrate to which nanoparticles 10 are applied. As such, because of the shape anisotropy of nanoparticles 10, nanoparticles 10 produce unique diffraction patterns both in the scatter pattern created and in the colors seen at those angles. In this way, nanofingerprint 18 can be verified using multi-layer confirmation (e.g., scatter pattern and colors) that component 12 is not a counterfeit product, as disclosed further herein. It may be appreciated that nanofingerprint 18 may be comprised of both the scatter pattern and the colors recorded at different angles/polarizations of light such that nanofingerprint 18 allows the receiver of component 12 to use multiple layers of information to verify component 12.

Referring still to FIG. 3A, nanofingerprints 18 may be created by using an algorithm, software programs, or by a human first looking at response 16 (FIG. 1A) and selecting the most prominent profiles or nanoparticles 10 that responded to challenge 14. With the number of prominent profiles identified, calculations may be done to determine the distance matrix. This distance information forms part of nanofingerprint 18. More particularly, FIG. 3A shows illustrative nanoparticle profiles 10 with the largest areas that are selected. The distance of each circled particle in the target pattern to every particle in a database pattern is calculated resulting in a distance matrix. This distance matrix is used to identify nearest neighbors, and the sum of the distances between nearest neighbors for each possible comparison between a target pattern and a database pattern is computed. The smallest such distance iₘ indicates the matching pattern.

Illustratively, FIG. 3B illustrates the x- and y-pixel location of all nanoparticle profiles within q=20 images which comprise the database 20. Nanoparticles 10 with the largest profile areas; i.e., those that covered the most pixels, are likely to be the most prominent in any image of the same fingerprint regardless of small differences in exposure and illumination. Therefore, image comparisons are made by sampling these most prominent profile areas. The particle profiles can be sorted by area, and the n profiles Pₘⁿ=(P₁, P₂, P₃ . . . Pₙ) with the largest areas can be selected in each database image, Pₘ, and compared with their n counterparts having the largest area in the target image, Tⁿ=(t₁, t₂, t₃ . . . tₙ).

Each database image subset Pₘⁿ can be compared with the target image subset Tⁿ by computing the shortest distance between each member of Pmn and its nearest neighbor in Tⁿ. These distances will be much shorter for matching images that are nearly aligned than for nonmatching images. This strategy is similar to the Hausdorff distance. Two sets of points are close in Hausdorff distance if every point in either set is close to some point in the other set. For images Pₘ and T, the distance d_{a-b} between each member of the target image subset Tⁿ and every member of database image subset Pₘⁿ is given by Equation (1) where (X_{pb}, Y_{pb}) is the location of particle Pb, and (Xₜₐ, Yₜₐ) is the location of ta.

d_{a-b}=\sqrt{(X_{pb}−Xₜₐ)²+(Y_{pb}+Yₜₐ)²} (1)

From the set of distances computed, the minimum distance dₘᵢₙₐ between each of the n nanoparticles ta in the target image subset Tⁿ and its closest neighbor in Pₘⁿ is identified. The sum of these distances is given by Equation (2), where iₘ is an index of how similar the distribution pattern of particles in image T is to any database image Pₘ. The database image Pₘ for which the similarity index iₘ is the smallest is identified as the most likely match.

iₘ=Σ₁ⁿdₘᵢₙₐ (2)

Twenty optical dark-field images of scattering patterns using gold nanoparticles 10 can be obtained and used to create the database. Each of the 20 images represents an individual nanofingerprint 18. For each pattern, a consecutive image can be taken without repositioning the fingerprint area. This consecutive image can be taken directly after the original image (<30 s) to demonstrate the difference in iₘ that would arise from slight differences in illumination. In addition, nanofingerprint 18 can be moved 5 μm in the x-direction and again in the y-direction, capturing images with translational repositioning. The translational shifts can be incorporated to encompass small imaging differences that might occur when the PUF is challenged in real quality-testing scenarios.

In various embodiments, a similar algorithm can be tested in which the nearest neighbors in particle profile area or color can be used rather than x, y location. In this strategy, each profile in the target image particle subset Tⁿ can be paired with its nearest neighbor in a database image Pₘ in terms of profile area or color.

This process can be done for each member of S, with the computation of the similarity index iₘ in each case (see Equation (2)). The match with the smallest similarity index can be taken as correct. This algorithm is successful in matching a portion of an image with its counterpart in a larger whole image, even when the partial image is of different scale from its counterpart in the whole image.

In one embodiment, as shown in FIG. 3C, as the micrographs are taken to prepare nanofingerprint 18, the algorithm disclosed herein and/or a macro may be used to remove the background from the image(s), sum together various pixels, and ultimately output a representation of nanofingerprint 18. For example, a macro or algorithm may be written as follows:

```
    n = getNumber(“How many divisions (e.g., 2 means quarters)?”, 2);
    id = getImageID( ):
    title = getTitle( );
    getLocationAndSize(locX, locY, sizeW, sizeH);
    width = getWidth( );
    height = getHeigt( );
    tileWidth = width / n;
    tileHeight = height / n;
for (y = 0; y < n; y++) {
offsetY = y * height / n;
  for (x = 0; x < n; x++) {
offsetX = x * width / n;
selectImage(id);
  call(“ij.gui.ImageWindow.setNextLocation”, locX + offsetX, locY + offsetY):
tileTitle = title + “ [“ + x + ”,“ + y + ”]”;
  run(“Duplicate....”, “title=” + tileTitle);
makeRectangle(offsetX, offsetY, tileWidth, tileHeight);
  run(“Crop”);
}
}
selectImage(id);
close( );
```

Each image may be converted to binary and the number of pixel responses may be analyzed compared to the background. From this, a number of tags may be produced from the original microscopy images. In one embodiment, based on a linear regression analysis, the number of response pixels may increase according to Equation (3):

y=582.73×(number of tags)+6519.10 (3)

Additionally, nanofingerprint 18 identifies the colors of the prominent profiles identified. Using the RGB scale, the selected nanoparticles 10 are identified by their color (or average color based on several nanofingerprints 18), such that not only the location or distance to neighboring nanoparticles 10 is identified but also the color response from that nanoparticle 10 at a particular polarization or angle of light also is identified. For color, neighbor relationships can be in a 3D RGB color space. In some cases, the profile areas can be imaged with a black and white CCD camera. The resulting diffraction-limited spots appear varying shades of grey depending on subtle illumination differences from image to image. These shades of grey are still defined on the RGB scale, although in this case they vary in only 1 D, along a line.

Where the average RGB value is used, the range of RGB values may be found by averaging the RGB values of each pixel for features that are auto-identified above a minimum RGB threshold. As shown in FIG. 3D, an ink comprising nanoparticles 10 may produce average RGB values as shown. Conversely, a second ink comprising nanoparticles 10 may produce different average RGB values, as shown in FIG. 3E.

RGB distance value is the Euclidean distance between two colors, as defined in Equation (3), where V 1 and V 2 are the colors being differentiated. R, G, and B denote the red, green, and blue component values, respectively. RGB distance does not correspond with human visual perception of color difference. For example, the RGB difference between red and yellow is equivalent to that of red and pink (see Equation (3)). Varying the shade, defined as two of the RGB values being set to zero while varying the third value, yields a color difference value of less than 100; whereas varying two or more R, G, and B values yields color difference values in the range of 60,000 to 130,000. The threshold for color change can be set as 1000, which is a tenfold increase over shade difference values and a twofold increase over white and black difference values which could experimentally result from differences in illumination.

∥V₁−V₂∥=√[(V_{1,R}−V_{2,R})²+(V_{1,G}−V_{2,G})²+(V_{1,B}−V_{2,B})²] (4)

The refractive index-sensitivity of metallic nanoparticles 10 is composition dependent which has implications for their use as environmental sensors for tamper-evident and aging labels. Two different colloidal compositions can be selected. Specifically, a mixture of gold and silver nanoparticles 10 can be selected that scatter yellow and red wavelengths in a medium of water. True color images can be taken with a color-camera mounted to an optical microscopy eyepiece fitting.

In embodiments, the quantitative color difference from varying environments demonstrates the ability to use these metallic nanoparticles 10 as environmental sensors. Moreover, the refractive index-sensitivity depends on shape and size as well as composition. Therefore, selection of metallic compositions and structures should lead to optimized sensing platforms for particular environments of interest. For example, gold-palladium bimetallic systems can monitor hydrogen uptake by palladium while other metallic systems can be functionalized for specificity to monitor outgassed components of interest. By selecting metallic nanoparticle compositions and structures, colorimetric sensors could be developed to detect oxygen (to indicate that a hermetic seal has been broken), hydrogen, and other outgassed components (to indicate aging of a system).

Therefore, it may be apparent, that for each nanoparticle 10 selected in response 16, the distance matrix and determined color of the selected nanoparticles 10 collectively forms nanofingerprint 18 for component 12.

Once created, nanofingerprint 18 may be uploaded or otherwise saved or stored in database 20 such that when a receiver or party receives component 12, that party can illuminate the portion of component 12 with nanoparticles 10 to determine and see the diffraction pattern created by nanoparticles 10. The party can then compare the diffraction pattern seen at that time with nanofingerprints 18 stored in database 20 (e.g., FIG. 3B) to confirm that the diffraction pattern seen on component 12 at the time component 12 is received matches a known nanofingerprint 18. With a match, it can be confirmed that component 12 is a legitimate product that can from the source it identifies. However, if the diffraction pattern seen by the receiver or party does not match any nanofingerprints 18 in database 20, then it is possible that the component is a counterfeit device.

Nanofingerprints for Anti-Counterfeiting Applications

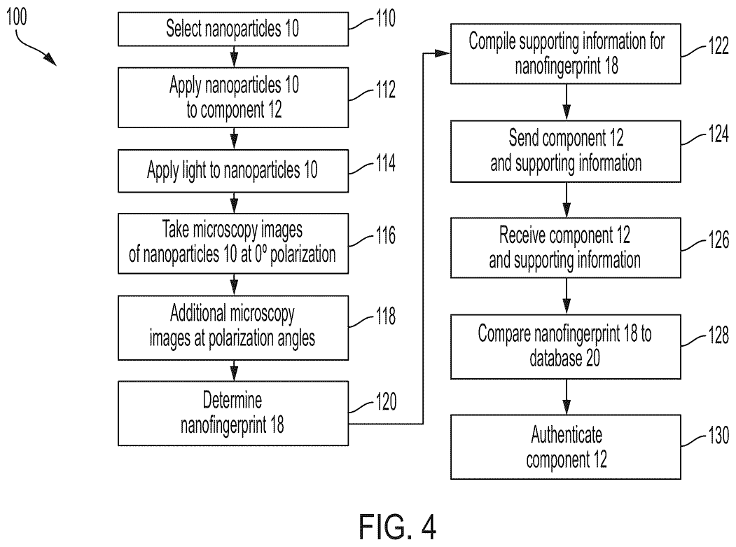

With respect to FIG. 4, a method 100 is disclosed providing steps for developing and using nanofingerprints 18 for anti-counterfeiting applications. In Step 110, nanoparticles 10 are selected. More particularly, a plurality of nanoparticles 10 may be selected and mixed together, where at least a portion of nanoparticles 10 includes nanoparticles having shape anisotropy. In other words, at least some of nanoparticles 10 selected have non-spherical shapes and, instead may be octopodal, rod or cylindrically-shaped, hexagonally-shaped, plate-shaped, and/or any other non-spherical shape. Because of the shape anisotropy of at least a portion of nanoparticles 10 selected, such nanoparticles 10 may exhibit different colors at different polarization angles of light.

Next, in Step 112, the selected nanoparticles 10 are applied to component 12. In one embodiment, nanoparticles 10 may be deposited onto a portion of component 12 through a liquid deposition method with a pipette or other mechanical device. In other embodiments, nanoparticles 10 may be incorporated into a portion of component 12, for example incorporated into an ink, paint, or coating on component 12. Depending on the material composition of nanoparticles 10, a coating may be applied to nanoparticles 10 to prevent oxidation thereof.

After nanoparticles 10 are applied to component 12, in Step 114, a light source is provided which can emit light onto the portion of component 12 with nanoparticles 10. The light may initially be at a polarization angle of 0°. In Step 116, a microscopy image (e.g., optical microscopy) is taken of nanoparticles 10 at 0° light polarization.

Next, in Step 118, additional microscopy images of nanoparticles 10 may be taken under varying polarization angles. As shown in Step 120, nanofingerprint 18 is determined based on the locations of the prominent nanoparticles and the colors of those prominent nanoparticles at each polarization angle. As disclosed herein, the locations of the prominent nanoparticles may be calculated and referenced through a distance matrix and the colors of the prominent nanoparticles may be determined using the RBG scale at each polarization angle.

Nanofingerprint 18 may require supporting information with respect to the parameters under which nanofingerprint 18 was determined. As such, in Step 122, the microscopy images, the parameters of the images (e.g., magnification), the conditions under which the images were obtained (e.g., air, water, temperature, humidity), the parameters of particles (e.g., weight, thickness, height, length, width, material composition, etc.), and the recorded distance/location information and color information for nanoparticles 10 are all compiled and, collectively, provide supporting information to understand nanofingerprint 18. The supporting information also is uploaded or otherwise saved or stored on database 20 (FIG. 1A) for later access. In this way, once nanoparticles 10 are applied to component 12, the resulting nanofingerprint 18 and all supporting information may be prepared and saved to database 20 for later access, as disclosed herein.

Next, in Step 124, component 12 may be sent or delivered to a receiver, external party, or any other source meant to receive component 12. Sent with component 12 is the supporting information for nanofingerprint 18. Once received in Step 126, the receiver of component 12 accesses database 20 to confirm that nanofingerprint 18 matches information in database 20, as shown in Step 128. More particularly, nanofingerprint 18 is compared to stored nanofingerprints 18 in database 20 and, if a match is made, the veracity and authentication of component 12 is complete, as shown in Step 130. In other words, if nanofingerprint 18 on component 12 matches a nanofingerprint 18 in database 20, then component 12 is an authentic product and is not counterfeit. However, if there is no match within database 20, this indicates to the receiver of component 12 that component 12 may be a counterfeit product. Various applications of nanofingerprints 18 may be used in the electronics or pharmaceutical industries. For examples, nanoparticles 10 may be used in the paint or ink on various electrical components or may be incorporated into labels for pharmaceutical packaging.

As noted herein, artificial intelligence methods may be used to authenticate component 12. For example, a convolutional neural network may be used, where an image set (e.g., tag stack 22) is input into a deep learning system to learn the features associated with that set. The image is tested against the networks that assess the probability of that image matching a pre-trained image set. Such artificial intelligence methods and systems may reduce readout or matching times to improve the efficiency of nanofingerprints 18 in anti-counterfeiting applications.

Convolutional neural networks may be trained to authenticate nanofingerprints 18 through course-grain authentication (e.g., systematic production parameters, such as type of deposition material, preparation method, etc.). Additionally, the convolutional neural networks use fine-grain authentication to match a PUF to a product identification. Overall, the authentication process using artificial intelligence may be reduced to seconds (e.g., 1-2 seconds), thereby making it applicable to large volume products.

### Examples

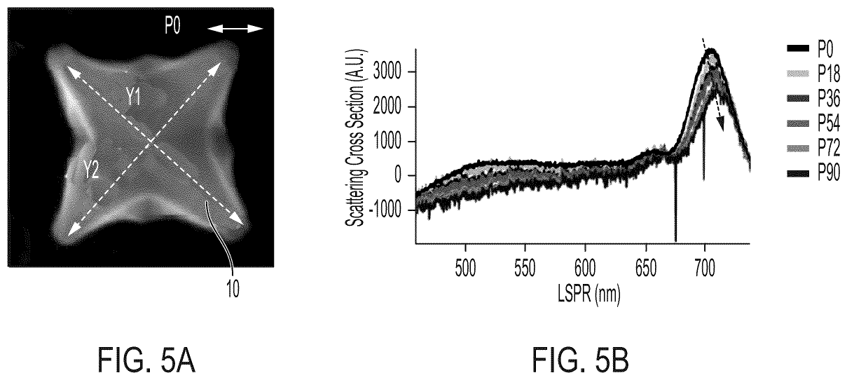

To demonstrate the scatter pattern and color identification possibilities of anisotropic nanoparticles, the following examples are disclosed. As shown in FIGS. 5A and 5B, an anisotropic nanoparticle 10 is exposed to polarized light at the polarization angles shown in FIG. 5B produces polarization-dependent scattering wavelengths (plotted on a graph of the localized surface plasmon resonance (“LSPR”) and the scattering cross-section). More particularly, nanoparticle 10 of FIG. 5A is a gold-palladium octopodal nanoparticles having a first face with a diagonal length of approximately 158.4 nm (“Y1”) and a second face with a diagonal length of approximately 136.1 nm (“Y2”).

When light is applied to nanoparticle 10 of FIG. 5A, a blue color is shown at a polarization angle of 0°, a green color is shown at a polarization angle of approximately 18°, an indigo or purple color is shown at a polarization angle of approximately 36°, an orange color is shown at a polarization angle of approximately 54°, a light blue color is shown at a polarization angle of approximately 72°, and a red color is shown at a polarization angle of approximately 90°, as seen in FIG. 5B. In this way, it is apparent that the shape anisotropy of nanoparticle 10 of FIG. 5A reflects different colors dependent upon the polarization angle of the light. As such, when using anisotropic nanoparticles 10 for anti-counterfeiting applications, not only does the nanofingerprint 18 indicate the positional relationship of nanoparticles 10 but the change in color of the prominent nanoparticles 10 is another layer of authentication available to confirm the veracity of component 12.

In this example, nanofingerprint 18 may include the color changes of nanoparticle 10 at each of the six polarization angles such that component 12 cannot be authenticated unless database 20 includes a nanofingerprint with the same location and same color change of nanoparticles 10 at each polarization angle. Alternatively, nanofingerprint 18 may include the color change between polarization angles 0° and 90° only, which still provides an additional layer of security when authenticating component 12 because, in addition to identifying the scatter locations of prominent nanoparticles 10, the color change between polarization angles 0-90° also has to be confirmed in order to ensure the veracity of component 12. It may be appreciated that nanoparticle 10 of FIG. 5A shows a strong color response to different polarizations, noting that in FIG. 5B, the color change from 0 to 90° is from blue to red. It may be apparent that nanoparticles which exhibit strong color changes, such as color changes of red to green, red to black, or red to blue, may be preferable so the color change is easily identifiable.

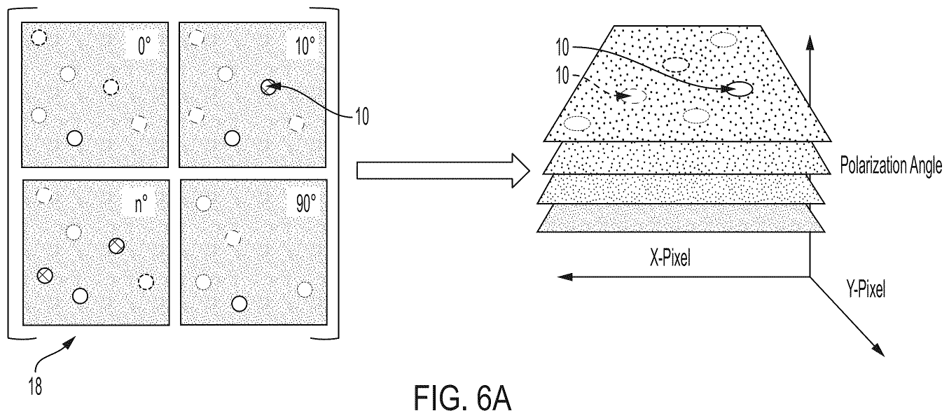

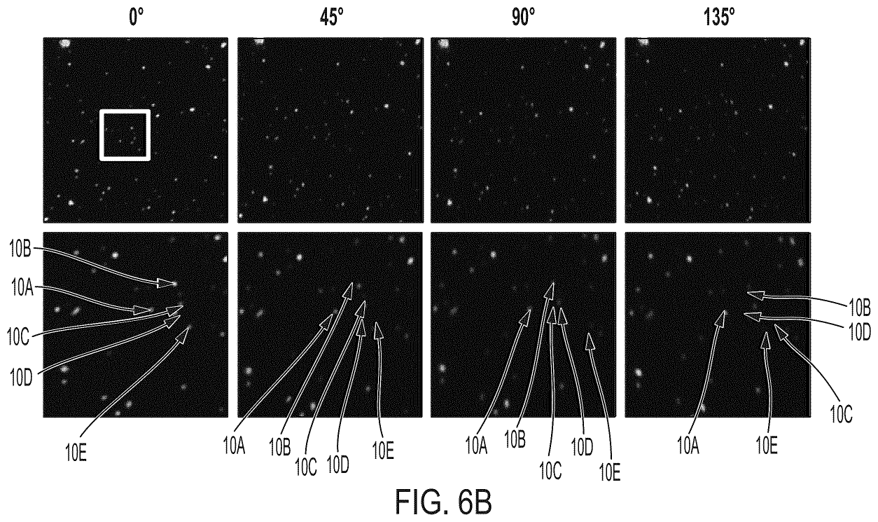

Referring to FIGS. 6A and 6B, a series of microscopy images at the denoted polarization angles are shown. With respect to FIG. 6A, the microscopy imagines define nanofingerprint 18 and are used to develop or produce a tag stack 22 associated with each component 12. Tag stack 22 is used to verify the authenticity of component 12 by comparing the nanofingerprint 18 produced by component 12 with tag stack 22. More particularly, and with respect to FIG. 6B, the identified nanoparticles 10A, 10B, 10C, 10D, and 10E exhibit color changes over the different polarization angles. More particularly, nanoparticles 10A-10E are rod-shaped nanoparticles and, therefore, have shape anisotropy. As such, nanoparticles 10A-10E emit reflect different colors of light depending on the polarization angle and, collectively, can be used to define nanofingerprint 18 because the location and the color change across the polarization angles provides multiple layers of authenticating component 12 with such nanoparticles. As shown in FIG. 6B, nanoparticle 10A is approximately red at 0° polarization and generally maintains its red color through 45°, 90°, and 135° polarization angles. Nanoparticle 10B is approximately yellow at 0° polarization and is approximately black at 135° polarization. Nanoparticle 10C is approximately red at 0° polarization and is approximately black at 135° polarization. Nanoparticle 10D is approximately green at 0° polarization and is approximately black at 135° polarization. Nanoparticle 10E is approximately red at 0° polarization and is approximately black at 135° polarization. In this way, nanoparticles 10A-10E exhibit a strong response to polarization changes.

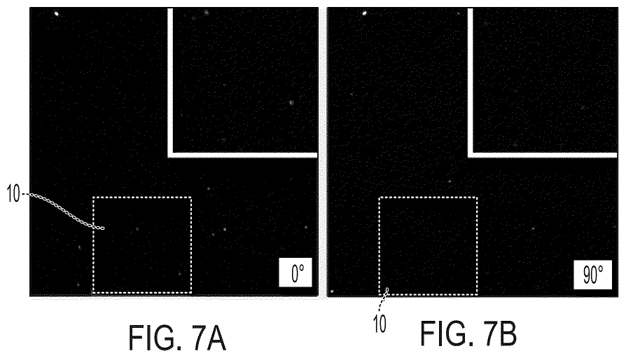

Referring now to FIGS. 7A and 7B, optical microscopy images were taken of anisotropic nanoparticles 10. As seen in FIG. 7A, nanoparticle 10 emits a red color at 0° polarization but is black at 90° polarization, as shown in FIG. 7B. In this way, it is apparent that this nanofingerprint 18 can verify component 12 by comparing the color change of nanoparticle 10 from 0° to 90° polarization.

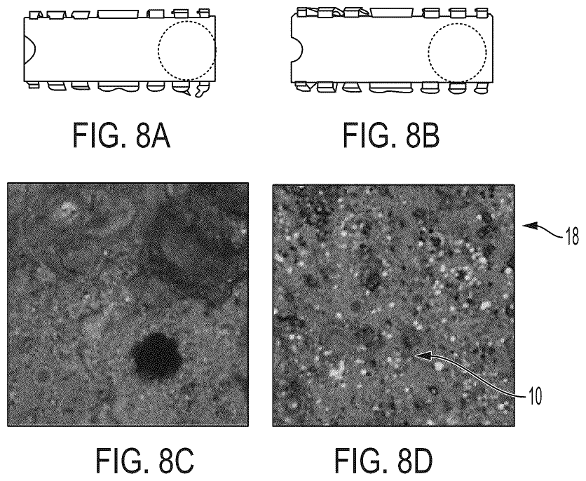

Referring now to FIG. 8, the same electronic components 12 were used to demonstrate the presence of nanofingerprint 18. In FIG. 8A, component 12 does not include any nanoparticles 10 and, as such, the microscopy image in FIG. 8C does not show any scatter pattern. However, in FIG. 8B, nanoparticles 10 were applied to a portion of component 12 according to the method of FIG. 4, and the microscopy image in FIG. 8D shows the scatter pattern of nanoparticles 10. In this way, the party receiving component 12 can verify if component 12 has appropriately been tagged using nanoparticles for anti-counterfeiting because nanofingerprint 18 is plainly apparent under predetermined microscopy parameters compared to the untagged component 12 in FIG. 8A.

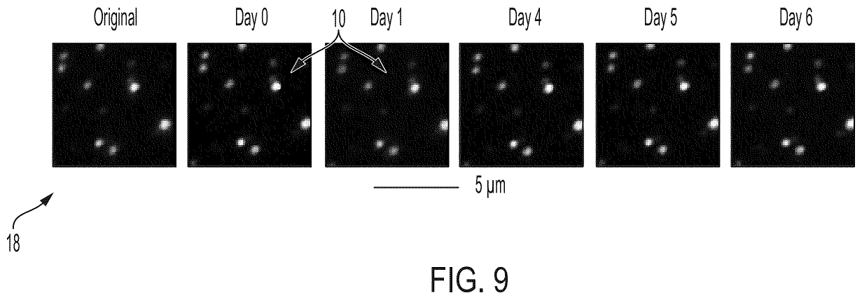

Referring to FIG. 9, optical micrographs of tag stack 22 does not show any significant change in the location and/or color of nanoparticles 10. As such, it may be appreciated that nanofingerprints 18 are stable over time which minimizes concerns that nanofingerprint 18 would not match the images of component 12 at the time component 12 is authenticated.

As shown in the examples provided herein, under microscopy conditions, nanofingerprints 18 are observed which allow for the detection of counterfeit components. It has been demonstrated herein that nanofingerprints 18 both provide the relative locations of nanoparticles and the colors of nanoparticles at varying polarization angles, and, collectively, this information provides multi-layer authentication of component 12.

Additionally, it is advantageous that the use of randomly arranged anisotropic nanoparticles achieved by dropcast methods thus warrants attention for use in optical PUFs. Several uses of metallic nanoparticles as refractive index-based sensors can be developed. For example, a hybrid gold-palladium nanoparticle exhibits a red-shifted LSPR upon uptake of hydrogen to form palladium hydride, and the LSPR of silver nanoparticles shifts upon oxidation. Therefore, it is advantageous that the random patterning of gold nanoparticles, by demonstrating that subsequent optical imaging of their far-field scattering, creates unique images that can serve as nanofingerprints. These nanofingerprints have implications in anti-counterfeit measures for both pharmaceutical and electronic industries, and it is demonstrated that registry-free single particle correlation is feasible. Moreover, these nanofingerprints can also be used as colorimetric, refractive index-based environmental sensors on account of the local refractive index dependence on LSPR of metallic nanoparticles. Additionally, different shapes, sizes, and compositions of nanoparticles, using the same facile dropcast method presented here, can lead to multifunctional sensing platforms that serve as both anti-counterfeit tags (nanofingerprints) and refractive index-based environmental sensors (tamper and aging indicators).

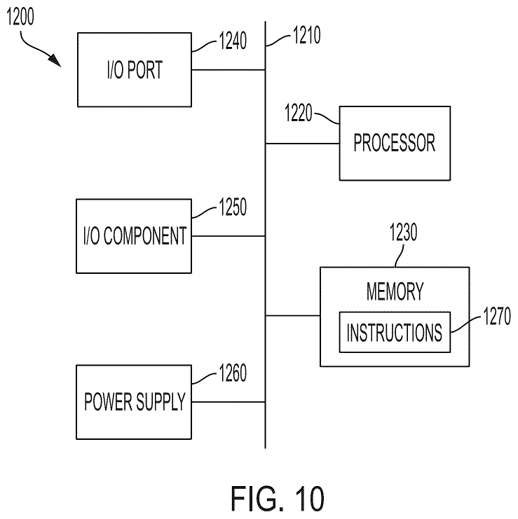

As disclosed herein, a computer or other processing device may be used to compile the information of nanofingerprint 18 and/or facilitate the comparison of nanofingerprint 18 to database 20. FIG. 10 is a block diagram depicting an illustrative computing device 1200 incorporated in accordance with embodiments of the present disclosure. The computing device 1200 may include any type of computing device suitable for implementing aspects of embodiments of the disclosed subject matter. Examples of computing devices include specialized computing devices or general-purpose computing devices such “workstations,” “servers,” “laptops,” “desktops,” “tablet computers,” “hand-held devices,” “smartphones,” “general-purpose graphics processing units (GPGPUs),” and the like, all of which are contemplated within the scope of the present disclosure.

In embodiments, the computing device 1200 includes a bus 1210 that, directly and/or indirectly, couples the following devices: a processor 1220, a memory 1230, an input/output (1/O) port 1240, an 1/O component 1250, and a power supply 1260. Any number of additional components, different components, and/or combinations of components may also be included in the computing device 1200. The 1/O component 1250 may include a presentation component configured to present information to a user such as, for example, a display device, a speaker, a printing device, and/or the like, and/or an input component such as, for example, a microphone, a joystick, a satellite dish, a scanner, a printer, a wireless device, a keyboard, a pen, a voice input device, a touch input device, a touch-screen device, an interactive display device, a mouse, and/or the like.

The bus 1210 represents what may be one or more busses (such as, for example, an address bus, data bus, or combination thereof). Similarly, in embodiments the computing device 1200 may include a number of processors 1220, a number of memory components 1230, a number of I/O ports 1240, a number of I/O components 1250, and/or a number of power supplies 1260. Additionally, any number of these components, or combinations thereof, may be distributed and/or duplicated across a number of computing devices.

In embodiments, the memory 1230 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like.

In embodiments, the memory 1230 stores computer-executable instructions 1270 for causing the processor 1220 to implement aspects of embodiments of system components discussed herein and/or to perform aspects of embodiments of methods and procedures discussed herein. For example, instructions 1270 can include method and process steps related to the dropcast deposition method, the image processing method, and/or the method of establishing the security layer for nanofingerprints used in the anti-counterfeit applications.

The computer-executable instructions 1270 may include, for example, computer code, machine-useable instructions, and the like such as, for example, program components capable of being executed by one or more processors 1220 associated with the computing device 1200. Program components may be programmed using any number of different programming environments, including various languages, development kits, frameworks, and/or the like. Some or all of the functionality contemplated herein may also, or alternatively, be implemented in hardware and/or firmware.

The illustrative computing device 1200 shown in FIG. 10 is not intended to suggest any limitation as to the scope of use or functionality of embodiments of the present disclosure. The illustrative computing device 1200 also should not be interpreted as having any dependency or requirement related to any single component or combination of components illustrated therein. Additionally, various components depicted in FIG. 10 may be, in embodiments, integrated with various ones of the other components depicted therein (and/or components not illustrated), all of which are considered to be within the ambit of the present disclosure.

It should be understood that, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Various modifications and additions can be made to the exemplary embodiments discussed without departing from the scope of the presently disclosed subject matter. For example, while the embodiments described above refer to particular features, the scope of this disclosure also includes embodiments having different combinations of features and embodiments that do not include all of the described features. Accordingly, the scope of the subject matter disclosed herein is intended to embrace all such alternatives, modifications, and variations as fall within the scope of the claims, together with all equivalents thereof.

What is claimed is:

1. A method of using at least one nanoparticle for an anti-counterfeit application, comprising:
selecting the at least one nanoparticle having a non-spherical configuration;
providing the at least one nanoparticle on a substrate;
providing a light to the at least one nanoparticle;
determining a position of the at least one nanoparticle based on providing the light to the at least one nanoparticle;
determining a color of the at least one nanoparticle based on providing the light to the at least one nanoparticle;
defining a nanofingerprint based on the position and the color of the at least one nanoparticle; and
recognizing the nanofingerprint.

2. The method of claim 1, wherein the at least one nanoparticle has shape anisotropy.

3. The method of claim 2, wherein the at least one nanoparticle defines one of a spherical structure or a non-spherical structure, where the non-spherical structure is defined by at least an octopodal structure, a nanoplate structure, and a rod-shaped structure.

4. The method of claim 3, wherein providing the at least one nanoparticle includes providing a plurality of nanoparticles, and at least a portion of the nanoparticles includes non-spherical structures.

5. The method of claim 1, wherein providing the light includes polarizing the light to the at least one nanoparticle, further comprising determining the color of the at least one nanoparticle at the identified polarization of the light.

6. The method of claim 5, further comprising detecting a change of color based on the polarization of the light.

7. The method of claim 1, wherein defining the nanofingerprint includes providing at least one of a width, thickness, and length of the at least one nanoparticle.

8. The method of claim 1, further comprising performing an optical authentication of an article associated with the nanofingerprint based on at least the color associated with the at least one nanoparticle.

9. The method of claim 1, further comprising estimating the determined color using an RGB value.

10. A system of using at least one nanoparticle for an anti-counterfeit application, comprising:
at least one processor;
one or more computer-readable media having computer-executable instructions embodied thereon;
a light source; and
a microscope configured to produce at least a first microscopy image of the at least one nanoparticle in response to actuation of the light source at a first polarization angle, and the microscope being configured to produce a second microscopy image of the at least one nanoparticle in response to actuation of the light source at a second polarization angle, and the computer-readable media is configured to identify a color of the at least one nanoparticle at both the first and second polarization angles and compare the color of the at least one nanoparticle to a database stored on the processor.

11. The system of claim 10, wherein the at least one nanoparticle has shape anisotropy.

12. The system of claim 11, wherein the at least one nanoparticle defines one of a spherical structure or a non-spherical structure, where the non-spherical structure is defined by at least an octopodal structure, a nanoplate structure, and a rod-shaped structure.

13. The system of claim 12, wherein the at least one nanoparticle includes a plurality of nanoparticles, and at least a portion of the nanoparticles includes non-spherical structures.

14. The system of claim 10, wherein the database includes at least one of a width, thickness, and length of the at least one nanoparticle.

15. The system of claim 10, wherein the color is identified using an RGB value.
